(19) United States
(12) Patent Application Publication
(10) Pub. No.: US 2011/0186577 A1
(43) Pub. Date: Aug. 4, 2011

(54) Compartment cover seal system for defeating ballistic, incendiary, and liquid threats

(76) Inventors: Timothy Limbert, Mount Pleasant, SC (US); Joseph Kennedy, Chicago, IL (US)

(21) Appl. No.: 12/656,436

(22) Filed: Jan. 29, 2010

(51) Int. Cl. B65D 53/00; F16J 15/16

(52) U.S. Cl. 220/378; 277/345

(57) ABSTRACT

A seal system for a compartment having a barrier is disclosed, the barrier having an interior and a cover for an aperture disposed in the barrier, the cover opening outwardly relative to the interior. The seal system has a first seal extending from the cover that is disposed on an exterior of the compartment and a second seal extending from the cover. The seal system also has a structural assembly attached to an exterior of the barrier. The structural assembly surrounds at least a portion of an otherwise exposed perimeter of the second seal and a portion of an otherwise exposed perimeter of the first seal.

### TECHNICAL FIELD

The present disclosure relates to a seal assembly for compartment covers that resists penetration by ballistic and incendiary threats and liquids.

### BACKGROUND

One problem in protecting an interior space such as a vehicle cabin or other compartment from threat projectiles, such as from sniper fire and liquid intrusion, relates to seal systems for compartment covers. Conventional methods for sealing covers such as, for example, conventional exterior vehicle door and hatch seals, are ineffective for preventing liquid and threat projectile intrusion. Conventional seals are typically destroyed, knocked loose, or misshaped after a cover is opened and closed only a few times. As a result, conventional seal systems are ineffective in protecting passengers within a compartment from intrusion by threat projectiles and liquids such as water or incendiary fluids.

Thus, there exists a need for a sealing system that remains effective after numerous iterations of cover openings and closings, and substantially prevents intrusion of threat projectiles such as ballistic and incendiary threats, and liquids such as water. Preferably, such a seal system would be made of constructions that can be readily fabricated and incorporated into a compartment design at a reasonable cost, and even more preferably, can be added to existing compartments with minimal attachment points to compartment barriers such as, for example, a vehicle hull.

As the threats against armored vehicles increase and become more diverse, combinations of armor and seal systems are needed to defeat the various threats. A seal system that raises the protection level of a compartment to include liquids and threat projectiles, both incendiary and ballistic, is described.

### SUMMARY OF THE DISCLOSURE

In accordance with one aspect, the present disclosure is directed toward a seal system for a compartment having a barrier, the barrier having an interior and a cover for an aperture disposed in the barrier, the cover opening outwardly relative to the interior. The seal system includes a first seal extending from the cover that is disposed on an exterior of the compartment and a second seal extending from the cover. The seal system further includes a structural assembly attached to an exterior of the barrier. The structural assembly surrounds at least a portion of a perimeter of the second seal and a portion of the perimeter of the first seal.

### BRIEF DESCRIPTION OF THE DRAWINGS

FIG. 1 is a schematic illustration of an exemplary compartment cover having a seal system in accordance with the present invention;

FIG. 2 is a sectional illustration of the exemplary disclosed compartment cover seal system, viewed along line 2-2 of FIG. 1; and

FIG. 3 is an additional sectional illustration of the exemplary disclosed compartment cover seal system, viewed along line 3-3 of FIG. 1.

### DETAILED DESCRIPTION

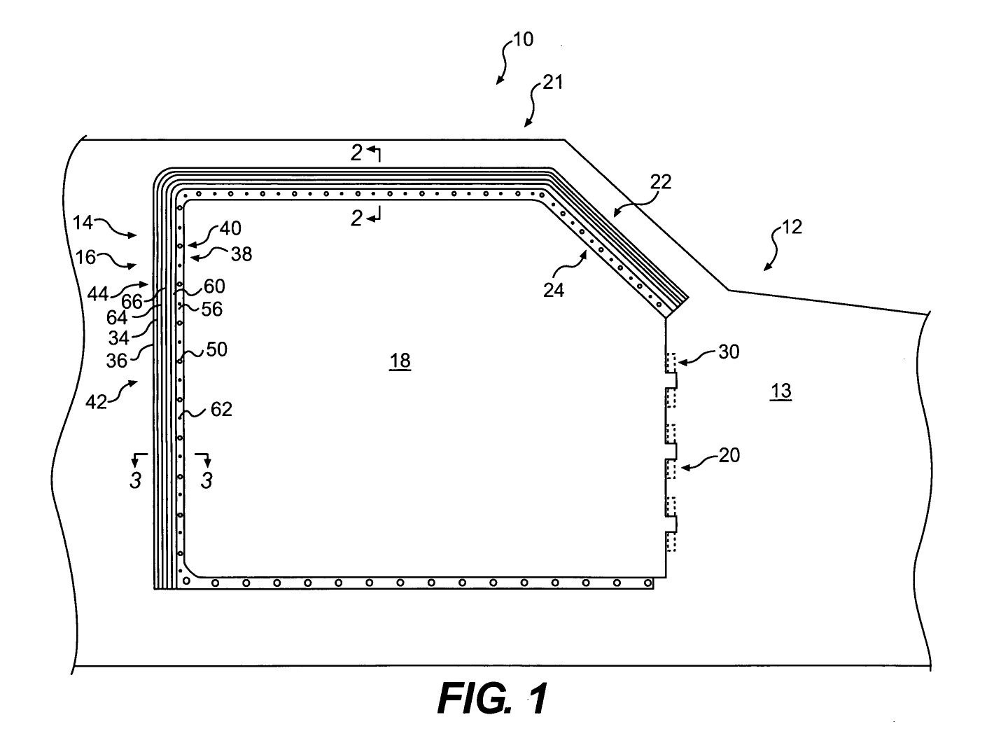

FIG. 1 illustrates an exemplary disclosed compartment 10, namely the forward passenger compartment of a land vehicle. Compartment 10 may, however, be any substantially or partially enclosed space for protecting personnel and other contents such as, for example, a passenger compartment of an aircraft, a naval vessel compartment, or a fortification such as a bunker or pillbox. Compartment 10 may include a barrier 12 and a cover 14 for selectively covering and exposing an aperture 16 disposed in barrier 12.

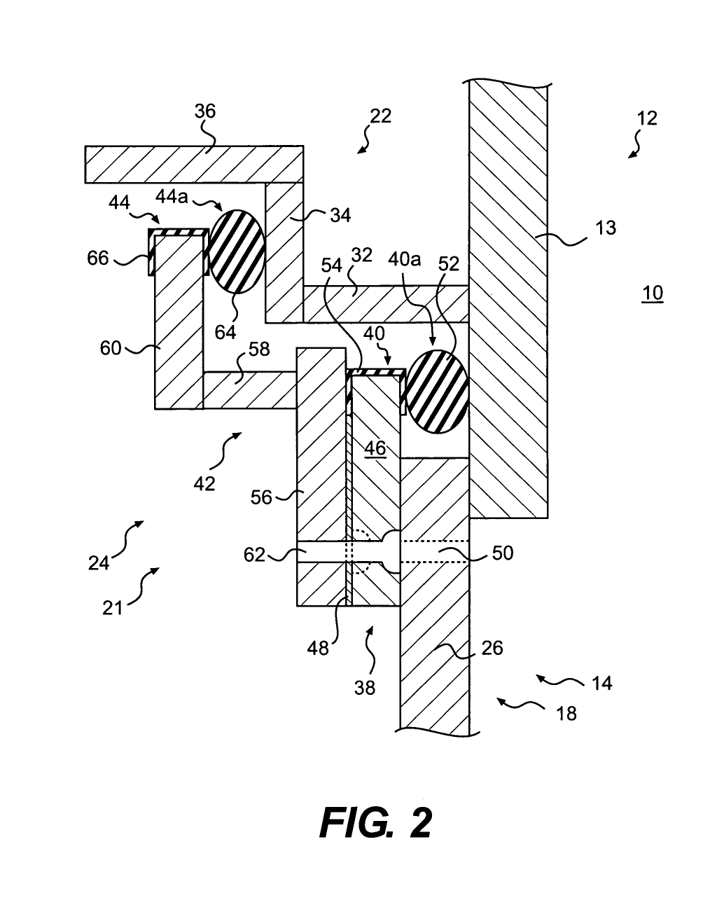

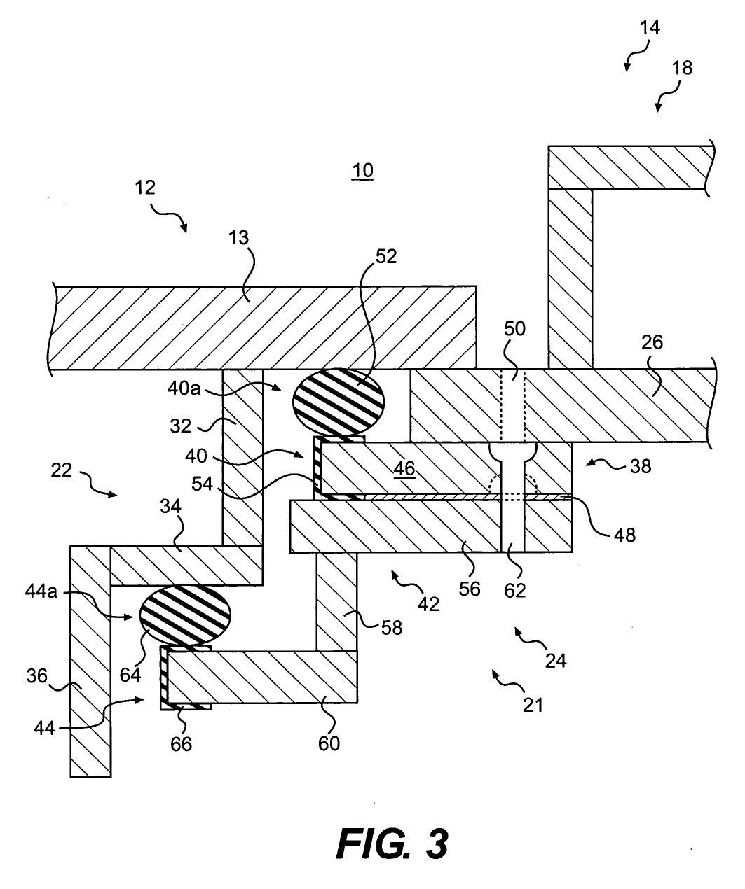

Barrier 12 may be any suitable structure for substantially or partially enclosing a space, and may include an interior. For example, barrier 12 may be an armored vehicle hull, an aircraft fuselage, naval vessel armor, or a structure built of armored plates. Barrier 12 may include one or more layers 13 of structural material such as, for example, a structural steel plate as shown in FIGS. 2 and 3. Referring back to FIG. 1, aperture 16 may be any opening in barrier 12 such as, for example, an ingress and egress for personnel into and out of compartment 10, an opening for allowing observation or the placement of a weapon such as a gunport, or an opening for ventilation or other mechanical requirements.

Cover 14 may be any covering for aperture 16 of barrier 12 that opens outwardly relative to the interior of barrier 12. For example, cover 14 may be an armored vehicle door, an aircraft or ship hatch, or a bunker door. As in the example shown in FIG. 1, cover 14 may be a door opening outwardly relative to a hull interior of a vehicle. Cover 14 may include a cover assembly 18 for partially or substantially covering aperture 16, an opening assembly 20 for displacing cover 14, and a seal system 21 including a structural assembly 22 and a seal assembly 24 for sealing cover 14 against barrier 12.

Cover assembly 18 may cover aperture 16 of barrier 12, and may reduce the threat of external projectiles to personnel and other contents within compartment 10. Cover assembly 18 may be configured from any suitable material such as, for example, structural steel or other suitable armored plates. As shown in FIGS. 2 and 3, cover assembly 18 may include a single layer 26, or may include a built-up section including, for example, multiple layers and apertures, depending on any functional requirements of cover assembly 18. In the FIG. 1 embodiment, cover assembly 18 is exterior to compartment 10, and opens outwardly in an exterior direction to compartment 10.

Returning to FIG. 1, opening assembly 20 may be any suitable structure or device for displacing cover 14 such as, for example, a rotating door hinge or an actuator for translating cover 14. For example, opening assembly 20 may include one or more hinge assemblies 30 on which cover assembly 18 may be rotatably attached.

As shown in FIGS. 2 and 3, structural assembly 22 of seal system 21 may be any suitable structural assembly extending from barrier 12 such as, for example, a plurality of structural elements 32, 34, and 36. Structural assembly 22 may have an outwardly stepped configuration formed by structural elements 32, 34, and 36, where structural element 34 may be substantially perpendicular to structural elements 32 and/or 36. Structural assembly 22 may be, for example, an armored gutter, which may be modified, for a vehicle. Any number of differently-shaped structural elements may be used to form structural assembly 22. For example, a single S-shaped plate, a series of interlocking U-shapes, or any other geometry may be used to form structural assembly 22, which may have a generally stepped configuration as depicted in FIGS. 2 and 3. Elements 32, 34, and 36, if not integrally formed, may be attached to each other by any suitable method such as, for example, by welding. Structural assembly 22 may be attached to barrier 12 by any suitable method. For example, structural element 32 of structural assembly 22 may be stitch-welded to layer 13 of barrier 12, thereby substantially avoiding excessive thermal effects from continuous welding. Structural assembly 22 may surround at least a portion of a perimeter of seal assembly 24, or may alternatively be disposed around an entire perimeter of aperture 16 of barrier 12.

As shown in FIGS. 2 and 3, seal assembly 24 of seal system 21 may include a carrier assembly 38 for attaching seal assembly 24 to cover 14, and a first seal 40 for sealing against barrier 12. Seal assembly 24 may extend from cover 14 and may also include a second seal flange assembly 42 attached to carrier assembly 38, and a second seal 44 for sealing against structural assembly 22. Seal assembly 24 may surround a portion or substantially an entire perimeter of aperture 16 of barrier 12.

Carrier assembly 38 may be any suitable assembly for mounting seal assembly 24 to cover 14. Carrier assembly 38 may include a flange 46 for supporting first seal 40, a spacer 48 for spacing second seal flange assembly 42 from carrier assembly 38, and a plurality of fasteners 50 for fastening seal assembly 24 to cover 14.

Flange 46 may be any suitable structural material such as, for example, structural steel. Flange 46 may include apertures for receiving fasteners 50. Flange 46 may be spaced from second seal flange assembly 42 via spacer 48, where spacer 48 may be any suitable spacer material known in the art for spacing one structural member from another structural member.

Fasteners 50 may be any suitable fastener known in the art such as, for example, bolts. Fasteners 50 may be received within apertures of flange 46 and layer 26 of cover assembly 18, and may be countersunk within flange 46 and/or layer 26. Fasteners 50 may thereby removably attach seal assembly 24 to cover 14.

First seal 40 may be a primary seal for sealing cover 14 with barrier 12. First seal 40 may be any suitable seal for sealing one element with another element such as, for example, an off-the-shelf seal or a seal that is custom-made for compartment 10. For example, first seal 40 may be an edge-mounted bulb seal, an extruded rubber seal, or any other suitable type of seal known in the art. First seal 40 may be preferably made from silicone, rubber, fluoroelastomer, EDPM foam, or EDPM vinyl, or may be made from any other suitable material in the art such as, for example, fiberglass, or silica or ceramic rope seals that are braided or twisted. First seal 40 may be configured to seal with any appropriate amount of resilient crush such as, for example, about 20% crush. For example, first seal 40 may be an edge-mounted bulb seal and may include a sealing element 52 and an attachment element 54, as is depicted in FIGS. 2 and 3. Element 54 may be an extruded element such as, for example, a metal U-shape that is coated with a plastic material. Element 54 may be edge-mounted onto flange 46, thereby edge-mounting seal 40 to carrier assembly 38. Thus, first seal 40 may extend inwardly from cover 14. It is also contemplated that first seal 40 may be mounted directly onto layer 26 of cover assembly 18.

Second seal flange assembly 42 may be any suitable assembly for mounting second seal 44, such as, for example, a plurality of structural elements 56, 58, and 60. Any number of differently-shaped structural elements may be used to form second seal flange assembly 42. For example, a single S-shaped plate, a series of interlocking U-shapes, or any other geometry may be used to form second seal flange assembly 42. Elements 56, 58, and 60 may be joined by welding and flange assembly 42 may be attached to flange 46 by any suitable method such as, for example, by a plurality of fasteners 62, as depicted in FIGS. 2 and 3. Fasteners 62 may be any suitable fastener known in the art such as, for example, bolts. Fasteners 62 may be received within apertures of flange 46 and element 56 of second seal flange assembly 42, and may be countersunk within flange 46 and/or element 56. Structural elements 56, 58, and 60 of flange assembly 42 may substantially correspond in length to structural elements 32, 34, and 36 of structural assembly 22.

Second seal 44 may be a secondary seal for sealing cover 14. Second seal 44 may be made from silicone, rubber, fluoroelastomer, EDPM foam, EDPM vinyl, fiberglass, or silica or ceramic rope seals that are braided or twisted. Second seal 44 may be similar to first seal 40, and may be any suitable seal in the art. For example, second seal 44 may include a sealing element 64 and an attachment element 66 that are similar to elements 52 and 54 of first seal 40. It is contemplated that second seal 44, as well as all of the elements of structural assembly 22 and seal assembly 24, may include fire-retardant materials.

Structural assembly 22 and seal assembly 24 of seal system 21 may form a seal between cover 14 and barrier 12. When cover 14 is closed against barrier 12, first seal 40 may form a seal with an exterior surface of layer 13 of barrier 12, and second seal 44 may form a seal against a surface of structural element 34 of structural assembly 22, as depicted in FIGS. 2 and 3. Sealing elements 52 and 64 may thereby be pressed to an appropriate crush to form a seal between cover 14 and barrier 12, as depicted in FIGS. 2 and 3. First seal 40 may thereby sealingly contact an exterior of barrier 12, and second seal 44 may thereby sealingly contact a surface of structural assembly 22. Also, as best seen in FIG. 2, structural assembly 22 partially surrounds, and thus helps protect, the otherwise exposed portions of both perimeter 44a of second seal 44 and perimeter 40a of first seal 40. Structural assembly 22 may surround at least a portion of perimeters 40a and 44a.

It is contemplated that an existing compartment 10 may be retrofitted with a retrofit kit including structural assembly 22 and seal assembly 24 to gain the benefits described herein. Any suitable method for retrofitting compartment 10 may be used. For example, an existing cover of existing compartment 10 may be removed and replaced with a new cover 14 including a new seal assembly 24. Alternatively, an existing cover may be drilled with apertures for receiving fasteners 50 and 62, and new seal assembly 24 may be attached to the existing cover. Also, for example, an existing rain gutter of compartment 10, which typically includes elements corresponding only to elements 32 and 34, may be modified, such as by adding an element corresponding to element 36, or may be removed and replaced with a new structural assembly 22 that may be stitch-welded to compartment 10.

The above exemplary disclosed seal system may provide a modular exterior design for substantially protecting intrusion of threat projectiles such as ballistic and incendiary threats, and liquids such as water, into an interior of a compartment. Seal system 21 may be utilized in newly manufactured compartments 10, or retrofitted onto existing compartments, and may require minimal attachment points to barrier 12. Seal system 21 may thereby increase protection of personnel and contents within compartment 10 against intrusion of incendiary and ballistic threats, and liquids such as water.

It will be apparent to those skilled in the art that various modifications and variations can be made to the disclosed apparatus and method. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A seal system for a compartment having a barrier, the barrier having an interior and a cover for an aperture disposed in the barrier, the cover opening outwardly relative to the interior, the seal system comprising:
a first seal extending from the cover that is disposed to sealingly contact an exterior of the barrier;
a second seal extending from the cover; and
a structural assembly attached to an exterior of the barrier and surrounding at least a portion of a perimeter of the second seal, wherein the second seal is disposed to sealingly contact the structural assembly.

2. The seal system of claim 1, wherein the structural assembly also surrounds a portion of a perimeter of the first seal.

3. The seal system of claim 1, wherein the second seal is positioned outwardly from the first seal relative to an opening direction.

4. The seal system of claim 1, wherein the structural assembly has an outwardly stepped configuration.

5. The seal system of claim 1, wherein one or both of the first and the second seals include one or more materials selected from fiberglass, silica rope, ceramic rope, silicone, rubber, fluoroelastomer, EDPM foam, and EDPM vinyl.

6. The seal system of claim 1, wherein one or both of the first and the second seals are edge-mounted seals.

7. A seal system for a vehicle, the vehicle having a hull and a door, the hull having an interior, and the door opening outwardly relative to the hull interior, the seal system comprising:
a structural assembly attached to an exterior of the hull and having a stepped configuration including a first element having a surface;
a first seal extending from the vehicle door, the vehicle door exterior to the hull, the first seal configured to abut an exterior surface of the hull; and
a second seal extending from the vehicle door, the second seal configured to abut the surface of the first element of the structural assembly.

8. The seal system of claim 7, wherein the structural assembly further includes a second element that is substantially perpendicular to the first element.

9. The seal system of claim 8, further including a first assembly that is attached to the vehicle door.

10. The seal system of claim 9, wherein the first seal is attached to the first assembly.

11. The seal system of claim 10, further including a second assembly that is attached to the first assembly.

12. The seal system of claim 11, wherein the second seal is attached to the second assembly.

13. The seal system of claim 12, wherein the second assembly includes a first and a second element that substantially correspond in length to the first and second elements of the structural assembly.

14. A seal system for a vehicle, the vehicle having a hull and a door, the hull having an interior, and the door opening outwardly relative to the hull interior, the seal system comprising:
a seal assembly removably attached to the vehicle door and having a seal;
a structural assembly attached to a hull exterior and surrounding at least a portion of an otherwise exposed perimeter of the seal.

15. The seal system of claim 14, wherein the seal assembly and the structural assembly are steel.

16. The seal system of claim 14, wherein the seal assembly is bolted to the vehicle door.

17. The seal system of claim 14, wherein the structural assembly is a modified armored gutter that is stitch-welded to the hull exterior.

18. The seal system of claim 14, further including a second seal disposed on the seal assembly.

19. The seal system of claim 18, wherein the plurality of seals are edge-mounted seals.

20. A retrofit kit for retrofitting a compartment, the compartment having a barrier with an exterior surface and defining a compartment interior, and a cover for an aperture disposed in the barrier, the cover opening outwardly relative to the compartment interior, the retrofit kit comprising:
a seal assembly including a plurality of seals, the seal assembly configured to be removably bolted to the cover; and
a structural assembly attached to an exterior surface of the barrier, the structural assembly configured for mounting the plurality of seals, wherein the structural assembly also surrounds at least a portion of the otherwise exposed perimeters of each of the plurality of seals.
